(19) United States
(12) Patent Application Publication
(10) Pub. No.: US 2013/0045252 A1
(43) Pub. Date: Feb. 21, 2013

(54) Apparatus for the Arrestment and Retention of Bromhidrosis

(71) Applicants: Thomas Douglas Rawlings, Coalport Shropshire (GB); Stephen Anthony Rawlings, Coalport Shropshire (GB); Robert Holmquist, Coalport Shropshire (GB)

(72) Inventors: Thomas Douglas Rawlings, Coalport Shropshire (GB); Stephen Anthony Rawlings, Coalport Shropshire (GB); Robert Holmquist, Coalport Shropshire (GB)

(21) Appl. No.: 13/643,397

(22) PCT Filed: Apr. 6, 2011
(86) PCT No.: PCT/EP2011/055379

§ 371 Date: Oct. 25, 2012

(30) Foreign Application Priority Data
May 6, 2010 (GB) 1007613.1
Oct. 27, 2010 (GB) 1018163.4

(51) Int. Cl. B01J 20/28; A01N 37/00; A01N 37/36; A01N 59/16; A43D 11/00; A01P 1/00; B01J 20/32; A41D 1/00; A43B 7/32; A01N 25/08; A01N 59/20

(52) U.S. Cl. 424/400; 502/416; 502/402; 514/557; 514/574; 424/617; 424/630; 424/618; 2/69; 36/83; 12/142 R

(57) ABSTRACT

An apparatus for adsorption of body odour comprising: an activated carbon layer for adsorbing body odour; a first material layer; and wherein the activated carbon layer is coupled to the first material layer.

### TECHNOLOGICAL FIELD

Embodiments of the present invention relate to apparatus for adsorption of body odour (including foot odour). In particular, they relate to apparatus for adsorption of body odour in a garment or footwear.

### BACKGROUND

Odour is usually produced when a person carries out exercise and perspires. Additionally, foot odour may be produced when a person's feet are enclosed by wearing shoes or boots. Many people find such body odour unpleasant and deodorants and anti-perspirants may be used to suppress body odour. However, these products can cause an irritation to certain groups of people. Additionally, where a person carries out exercise over a period of time, a deodorant or an anti-perspirant may not be able to sufficiently suppress the person's body odour.

It would therefore be desirable to provide an alternative apparatus to suppress body odour.

### BRIEF SUMMARY

According to various, but not necessarily all, embodiments of the invention there is provided an apparatus for adsorption of body odour comprising: an activated carbon layer for adsorbing body odour; a first material layer; and wherein the activated carbon layer is coupled to the first material layer.

The apparatus may further comprise a second foraminous material layer. The first material layer may be foraminous and the activated carbon layer may be sandwiched between the first foraminous material layer and the second foraminous material layer.

The apparatus may further comprise a third material layer including a plurality of open or closed cells. The layer may comprise one or more of: a polyester, a polyether or a poly urethane open or closed cell foam. The layer including a plurality of open or closed cells may be sandwiched between the activated carbon layer and the second foraminous material layer. The layer including a plurality of open or closed cells may be sandwiched between the activated carbon layer and the first foraminous material layer.

The activated carbon layer may be a layer of activated carbon cloth.

The activated carbon layer may be a layer of activated carbon felt.

The activated carbon layer may be a layer of activated carbon within a paper membrane.

The apparatus may further comprise one or more materials for capturing and retaining and destroying bacteria. The one or more materials may be in the activated carbon layer. The one or more materials may be in the first foraminous material layer and/or in the second foraminous material layer and/or in the third material layer. The one or more materials may be in the activated carbon layer and the first foraminous material layer and/or in the second foraminous material layer and/or in the third material layer. The one or more materials may comprise a carboxylic acid. The one or more materials may comprise citric acid. The one or more materials may comprise one or more noble metals. The one or more materials may comprise silver.

The apparatus may include an adhesive layer for enabling the apparatus to be applied to a garment or footwear with a domestic iron or using an industrial fusing press.

According to various, but not necessarily all, embodiments of the invention there is provided a garment or footwear comprising one or more apparatus as described in any of the preceding paragraphs.

According to various, but not necessarily all, embodiments of the invention there is provided a method of manufacturing an apparatus for adsorption of body odour comprising: providing an activated carbon layer for adsorbing body odour; providing a first material layer; and coupling the activated carbon layer to the first material layer.

The method may further comprise providing a second foraminous material layer. The first material layer may be foraminous and the activated carbon layer may be sandwiched between the first foraminous material layer and the second foraminous material layer.

The method may further comprise providing a third material layer including a plurality of open or closed cells. The third material layer may comprise one or more of: a polyester, a polyether or a poly urethane open or closed cell foam. The layer including a plurality of open or closed cells may be sandwiched between the activated carbon layer and the second foraminous material layer. The layer including a plurality of open or closed cells may be sandwiched between the activated carbon layer and the first foraminous material layer.

The activated carbon layer may be a layer of activated carbon cloth.

The activated carbon layer may be a layer of activated carbon felt.

The activated carbon layer may be a layer of activated carbon within a paper membrane.

The method may further comprise providing one or more materials for capturing, retaining and destroying bacteria. The one or more materials may be in the activated carbon layer. The one or more materials may be in the first foraminous material layer and/or in the second foraminous material layer and/or in the third material layer. The one or more materials may be in the activated carbon layer and the first foraminous material layer and/or in the second foraminous material layer and/or in the third material layer. The one or more materials may comprise a carboxylic acid. The one or more materials may comprise citric acid. The one or more materials may comprise one or more noble metals. The one or more materials may comprise silver. The one or more materials may comprise copper.

The method may further comprise providing an adhesive layer for enabling application to a garment or footwear with a domestic iron or using an industrial fusing press.

According to various, but not necessarily all, embodiments of the invention there is provided a method comprising: providing an apparatus as described in any of the preceding paragraphs; and coupling the apparatus to a garment or footwear.

### BRIEF DESCRIPTION

For a better understanding of various examples of embodiments of the present invention reference will now be made by way of example only to the accompanying drawings in which:

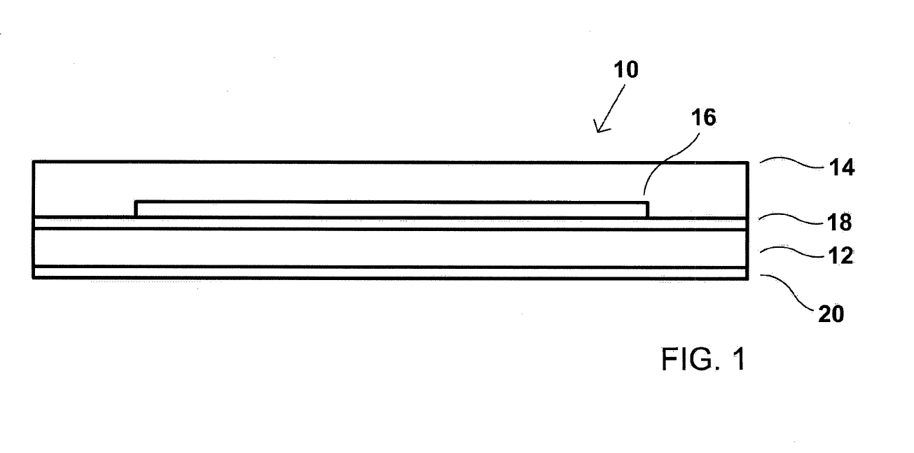

FIG. 1 illustrates a schematic cross sectional side view of an apparatus for adsorption of body odour according to various embodiments of the present invention;

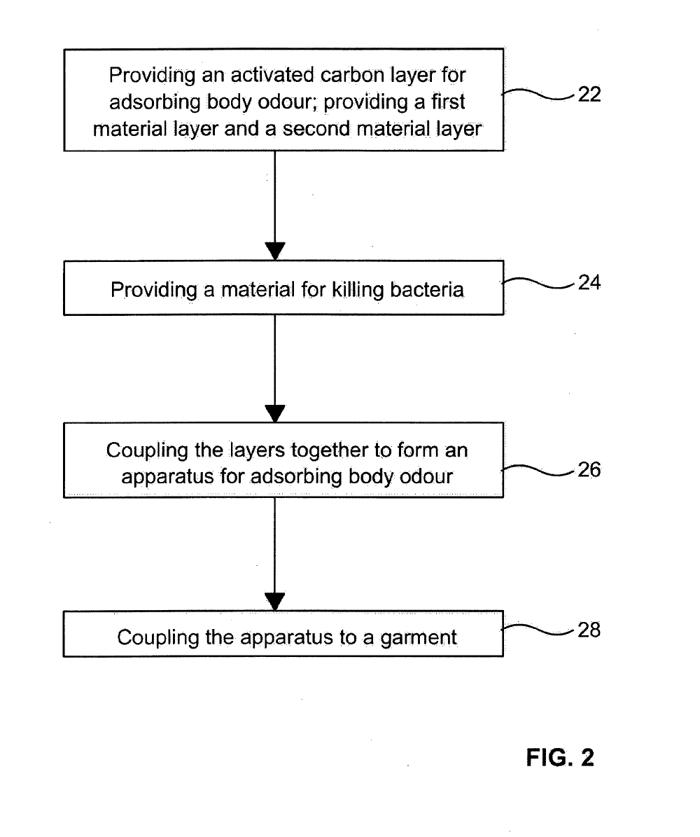

FIG. 2 illustrates a flow diagram of a method of manufacturing an apparatus according to various embodiments of the present invention;

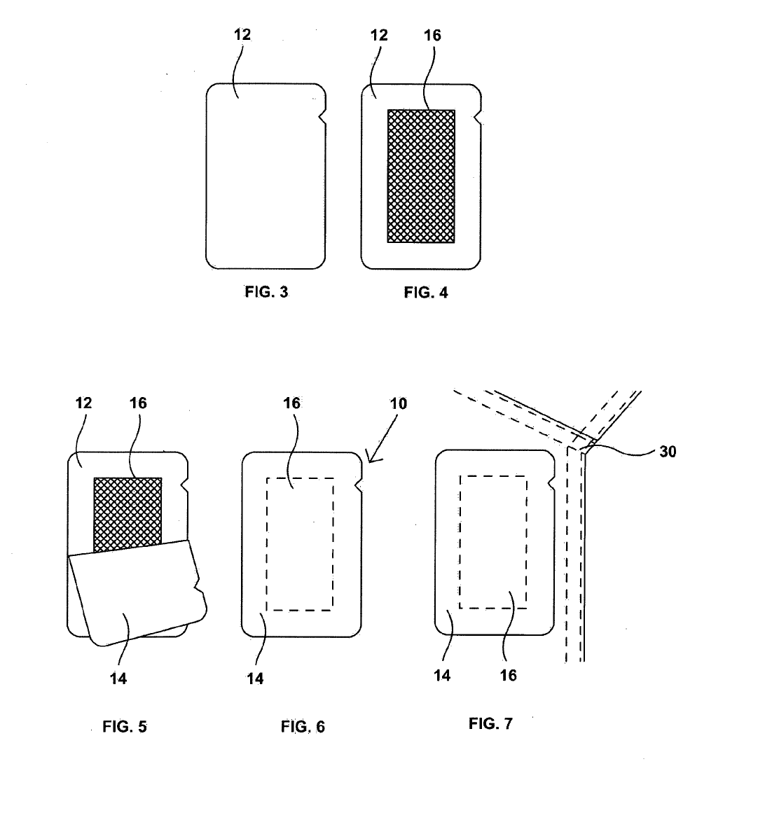

FIG. 3 illustrates a plan view of a first material layer forming a lower layer of the apparatus according to various embodiments of the present invention;

FIG. 4 illustrates a plan view of an activated carbon layer placed on the first material layer illustrated in FIG. 3;

FIG. 5 illustrates a plan view of a second material layer placed on the activated carbon layer and the first material layer illustrated in FIG. 4;

FIG. 6 illustrates a plan view of an apparatus according to various embodiments of the present invention;

FIG. 7 illustrates an apparatus according to various embodiments of the invention when in place near the vicinity of the armhole scye of a garment;

FIG. 8 illustrates a woman wearing a garment including an apparatus according to various embodiments of the present invention;

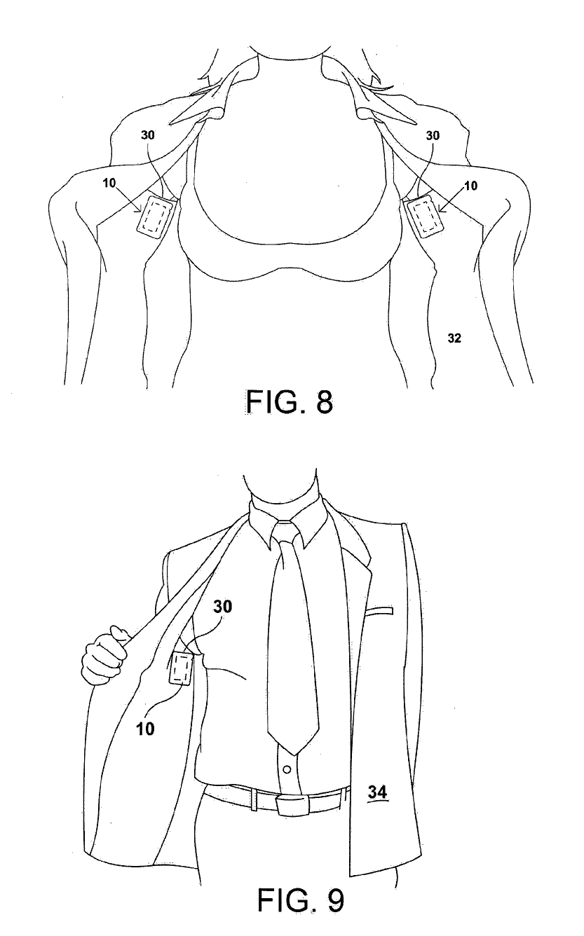

FIG. 9 illustrates a man wearing a garment including an apparatus according to various embodiments of the present invention;

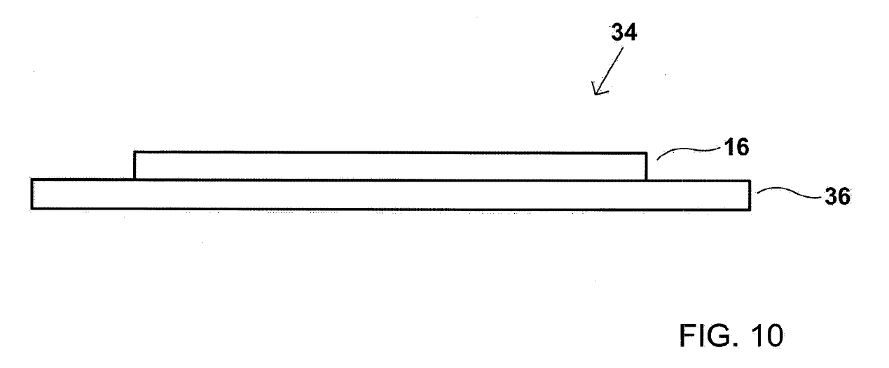

FIG. 10 illustrates a schematic cross sectional side view of another apparatus according to various embodiments of the invention;

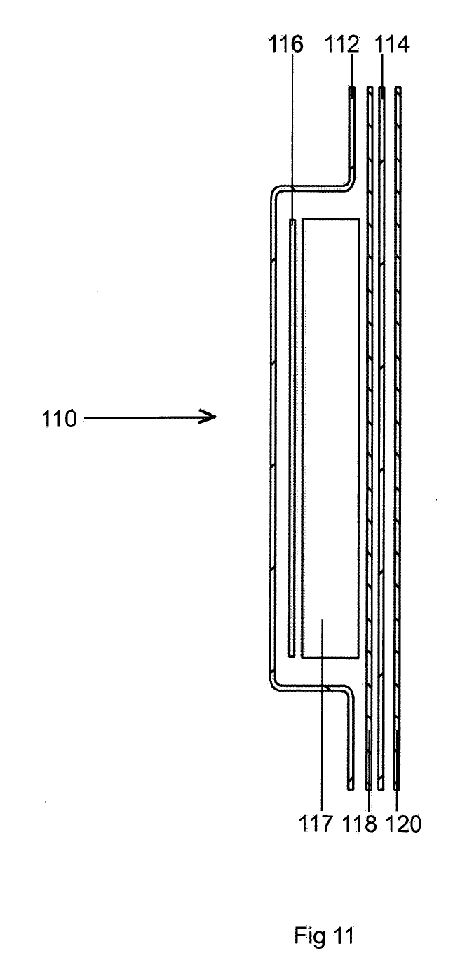

FIG. 11 illustrates a schematic cross sectional side view of an apparatus for adsorption of foot odour according to various embodiments of the present invention;

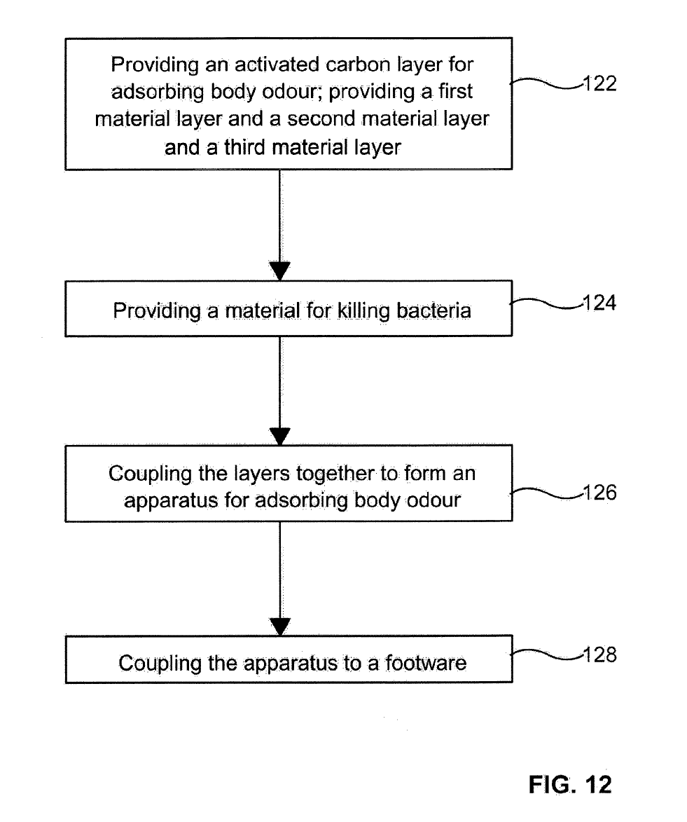

FIG. 12 illustrates a flow diagram of a method of manufacturing an apparatus according to various embodiments of the present invention;

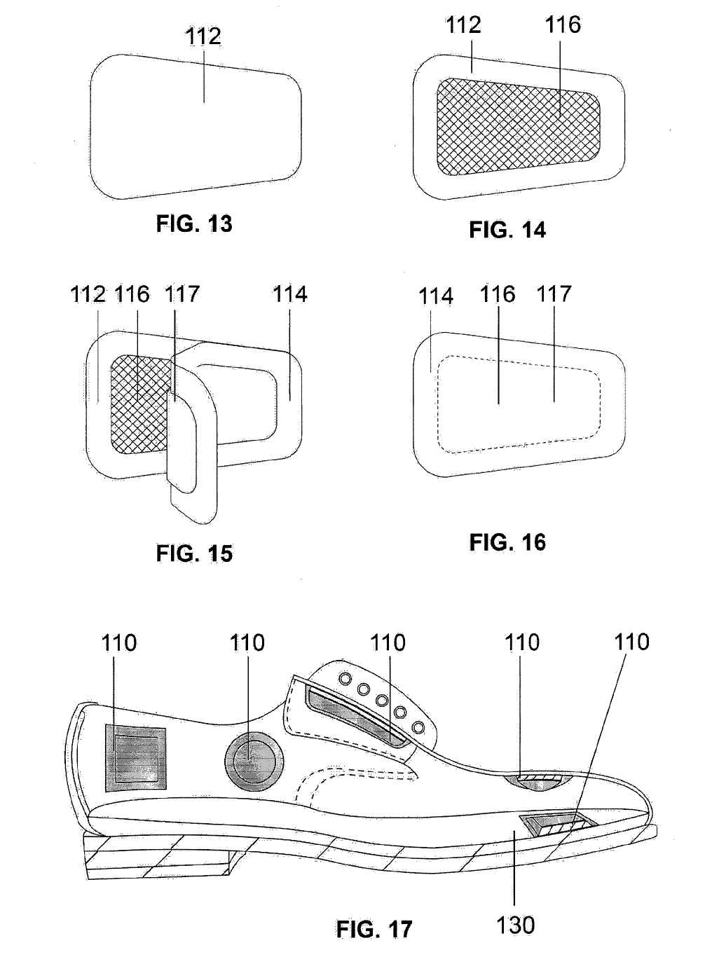

FIG. 13 illustrates a plan view of a first material layer forming a lower layer of the apparatus according to various embodiments of the present invention;

FIG. 14 illustrates a plan view of an activated carbon layer placed on the first material layer illustrated in FIG. 13;

FIG. 15 illustrates a plan view of a second and third material layer placed on the activated carbon layer and the first material layer illustrated in FIG. 14;

FIG. 16 illustrates a plan view of an apparatus according to various embodiments of the present invention; and

FIG. 17 illustrates an apparatus according to various embodiments of the invention when in place in footwear.

### DETAILED DESCRIPTION

In the following description, the wording ‘connect’ and ‘couple’ and their derivatives mean that any number or combination of intervening components can exist (including no intervening components) between the coupled/connected components.

FIG. 1 illustrates a cross sectional side view of an apparatus 10 for adsorbing body odour (including foot odour) according to various embodiments of the invention. The apparatus 10 may also be referred to as a ‘tag’ or as a ‘pad’.

The apparatus 10 has a laminate structure and comprises a first foraminous material layer 12, a second foraminous material layer 14, an activated carbon layer 16, a first adhesive layer 18 and a second adhesive layer 20.

The first foraminous material layer 12 may comprise fibres of any organic or non-organic material which may be (for example) woven, spun, knitted or moulded fabric. The first foraminous material layer 12 may be cotton gauze, material rayon or other synthetic material for example.

The second foraminous material layer 14 may comprise fibres of any organic or non-organic material which may be (for example) woven, spun, knitted or moulded fabric. The second foraminous material layer 14 may be cotton gauze, material rayon or other synthetic material for example.

The activated carbon layer 16 is sandwiched between the first foraminous material layer 12 and the second foraminous material layer 14. The activated carbon layer 16 may comprise any suitable carbon structure for adsorbing body odour. For example, the activated carbon layer 16 may be relatively flexible and include activated carbon cloth or activated carbon felt (including activated charcoal felt) or activated carbon paper. The activated carbon layer 16 is nano-porous and consequently has a comparatively large internal surface area for its size. This is configured to attract, trap and contain body odour molecules via the physical mechanism of Van Der Waals forces.

The process for manufacturing activated carbon cloth is well known in the art and will consequently not be described in detail here. Activated carbon cloth comprises a plurality of activated carbon fibres which may be knitted or woven together for example.

Activated charcoal felt comprises activated fibrous carbon and the fibrous carbon may be derived from an organic polymer fibre containing at least carbon, hydrogen, and oxygen. The organic polymer fibre may for example be pre-oxidised polyacronitrile or polyvinyl alcohol fibre. The organic polymer fibre may for example be a carbohydrate fibre. The fibres may be viscous rayon, cuprammonium rayon or cellulose ester rayon.

Activated charcoal felt may be produced from a viscous rayon precursor material which is non-woven and is needle punched into a backing scrim and then impregnated with a mixture of organic halides and carbonized in an atmosphere of carbon dioxide. The precursor material may be not more than 2 mm thick and may weigh no more than 260 g/m² and the charcoal felt may have a dry weight of not more than 144 g/m².

The first adhesive layer 18 is provided on the top surface of the first foraminous layer 12 and adheres the first foraminous layer 12 to the second foraminous layer 14 and to the activated carbon layer 16. The first adhesive layer 18 may comprise a thermoplastic polymer for example. In other embodiments, the apparatus 10 may not include the first adhesive layer 18 and instead, the first foraminous layer 12, the second foraminous layer 14 and the activated carbon layer 16 may be coupled together via stitching (by a sewing machine for example).

The second adhesive layer 20 is provided on the bottom surface of the first foraminous layer 12 and is arranged to adhere the apparatus 10 to a garment. The second adhesive layer 20 may comprise a thermoplastic polymer for example. In other embodiments, the apparatus 10 may not include the second adhesive layer 20 and instead, the apparatus 10 may be coupled to a garment by stitching the apparatus 10 to the garment (by a sewing machine for example).

The apparatus 10 also includes one or more materials for destroying odour causing bacteria. The first foraminous layer 12 and/or the second foraminous layer 14 and/or the activated carbon layer 16 may comprise the one or more materials for destroying bacteria. The one or more materials may include a carboxylic acid (citric acid for example), noble metals (silver for example) or some non-noble metals such as copper. In one embodiment for example, the first and/or second foraminous layer 12, 14 comprises citric acid and the activated carbon layer 16 includes silver. In various embodiments, the one or more materials may also be for destroying viruses.

Where one or more of the layers 12, 14 or 16 is to comprise a carboxylic acid, the layer 12, 14 or 16 is immersed in a solution comprising the carboxylic acid. The layer 12, 14, or 16 is then removed from the solution and then left to dry. When the layer 12, 14 or 16 is dry, the layer 12, 14 or 16 forms a nanosuspension comprising crystals of carboxylic acid. Where the activated carbon layer 16 is to comprise carboxylic acid, the concentration of the acid in the solution may be between 2% to 5% to prevent saturation of the activated carbon layer 16 by the acid.

Where one or more of the layers 12, 14 or 16 is to comprise a metal such as copper or silver, the layer 12, 14 or 16 may be sprayed with (or immersed in) a solution comprising the metal and then left to dry. When the layer 12, 14 or 16 is dry, the layer 12, 14 or 16 forms a nanosuspension comprising the metal.

Embodiments of the present invention provide several advantages. One such advantage is that the apparatus 10 may be incorporated into a garment and be used to adsorb body odour. Consequently, even if a person uses little or no deodorant or anti-perspirant, the apparatus 10 suppresses body odour from that person.

The use of activated carbon cloth as the activated carbon layer 16 may be advantageous in that activated carbon cloth is relatively pure and has relatively consistently uniform nanoporous structures (when compared with activated charcoal felt) which result in the activated carbon cloth having relatively high Van Der Waals forces and being effective at adsorbing body odour.

Another advantage provided by embodiments of the present invention is that the apparatus 10 may also include one or more materials for destroying odour causing bacteria. By destroying bacteria that produce body odour, the one or more materials may help to additionally suppress the production of body odour.

A further advantage provided by embodiments of the invention is that the second adhesive layer 20 may enable the apparatus 10 to be applied to a garment or footwear with a domestic iron at a user's home or using an industrial fusing press at a factory. Different types of adhesives can be used with different properties depending on the specific application. For example, they can have a higher tack or can be activated at a lower temperature.

FIG. 2 illustrates a flow diagram of a method of manufacturing an apparatus 10 according to various embodiments of the present invention. At block 22, the method includes providing the activated carbon layer 16, the first foraminous material layer 12 and the second foraminous material layer 14.

At block 24, the method includes providing the apparatus 10 with one or more materials for destroying bacteria (as described in the preceding paragraphs).

At block 26, the method includes coupling the layer 12, 14 and 16 together to form the apparatus 10. In various embodiments, block 26 may include the application of heat to melt the first adhesive layer 18 and thereby couple the layers 12, 14, 16 together. A silicon based paper or polymer backing may be provided over the second adhesive layer 20 to prevent the second adhesive layer 20 from adhering to other objects. The paper or polymer backing maybe printed on with a brand identity, application instructions or other distinguishing graphics. In other embodiments, block 26 may include stitching the layers 12, 14 and 16 together.

At block 28, the method includes coupling the apparatus 10 to a garment. In various embodiments, block 28 may include placing the apparatus 10 on a garment and then include the application of heat to melt the second adhesive layer 20 and thereby couple the apparatus 10 to the garment (once the second adhesive layer 20 has re-solidified).

The manufacture of an apparatus 10 and the coupling of the apparatus 10 to a garment will now be described with reference to FIGS. 3 to 7.

As shown in FIG. 3 a foraminous material layer 12 to which a fusible adhesive coating 18 is applied, is cut to a predetermined pattern and placed with the fusible coating uppermost. The activated carbon layer 16 is placed in position on the layer of a foraminous material layer 12 as shown in FIG. 4, and then a second layer of foraminous material layer 14 is placed over the first layer so as to sandwich the activated carbon layer 16 between the two layers of foraminous material as shown in FIG. 5.

The three pieces of fabric are then placed together to allow the adhesive 18 on the foraminous material 12 to melt fusing the three pieces of fabric together to form the apparatus 10 as shown in FIG. 6. The pad can then be incorporated in the armhole scye 30 of a garment as shown in FIG. 7. The apparatus 10 can be positioned in the garment by various means such as: stitching it into the armhole scye of the garment; or stitching onto the lining of the garment on the armhole scye area; or adhering it to the body of the garment in the area of the armhole scye; or adhering it to the lining of the garment in the area of the armhole scye.

In FIG. 8 an odour adsorbing apparatus 10 according to various embodiments of the invention is incorporated in the armhole scye 30 of a garment 32 so that in use the apparatus 10 lies just below the armpit and absorbs odour generated in this area. FIG. 8 illustrates the apparatus 10 incorporated into a garment worn by a female and FIG. 9 shows how the apparatus 10 may be incorporated into the type of garment worn by a male. In this case the apparatus 10 is incorporated into the armhole scye 30 of a garment 34.

A garment may have apparatus incorporated in it by cutting the apparatus to a size and shape to fit in the base of armhole scyes of the garment. The garment may for example be a jacket, dress, blouse, shirt, coat or jumper or tracksuit or any other garment having armholes.

The apparatus may be incorporated in a similar manner into other garments such as blouses, shirts, etc. as described above.

In use the activated carbon layer 16 absorbs odour and when the garment is washed the pad can be left in position since the activated carbon layer 16 and the cotton gauze are washable and the odour adsorption properties are not destroyed by normal washing.

FIG. 10 illustrates a cross sectional side view diagram of another apparatus 34 according to various embodiments of the present invention. In these embodiments, the apparatus 34 includes a layer of material 36 and an activated carbon layer 16 (as described above) coupled to the layer of material 36. The layer of material 36 may be any material that provides support to the activated carbon layer 16 and may or may not be foraminous. The layer of material 36 and the activated carbon layer 16 may be coupled via adhesive or stitching.

The apparatus 34 may be incorporated into an inside lining of a garment so that the inside lining provides a foraminous material layer overlaying the activated carbon layer 16. The apparatus 34 may be coupled to the inside lining of a garment via adhesive or via stitching.

The blocks illustrated in the FIG. 2 may represent steps in a method and/or sections of code in a computer program. For example, the blocks in FIG. 2 may be executed by one or more processors to control the automated manufacture of an apparatus 10. The illustration of a particular order to the blocks does not necessarily imply that there is a required or preferred order for the blocks and the order and arrangement of the block may be varied. Furthermore, it may be possible for some steps to be omitted.

FIG. 11 illustrates a cross sectional side view of an apparatus 110 for adsorbing foot odour according to various embodiments of the invention. The apparatus 10 may also be referred to as a ‘tag’ or as a ‘pad’. It should be appreciated that foot odour is a form of body odour and is produced by a person's feet.

The apparatus 110 has a laminate structure and comprises a first foraminous material layer 112, an activated carbon layer 116, a first adhesive layer 118, a second foraminous material layer 114, a third material layer of open cell Polyether polyurethane foam or any type of polymer based of open or closed cell foam 117 and a second adhesive layer 120.

The first foraminous material layer 112 may comprise fibres of any organic or non-organic material which may be (for example) woven, spun, knitted or moulded fabric. The first foraminous material layer 112 may be cotton gauze, material rayon or other synthetic material for example.

The second foraminous material layer 114 may comprise fibres of any organic or non-organic material which may be (for example) woven, spun, knitted or moulded fabric. The second foraminous material layer 114 may be cotton gauze, material rayon or other synthetic material for example.

The open or closed cell foam 117 comprises any open or closed cell polymer based foam and is placed under/adjacent the activated carbon layer 116.

The activated carbon layer 116 is sandwiched between the first foraminous material layer 112 and the open cell foam 117. The second foraminous material layer 14 is positioned adjacent the open cell foam 117. The activated carbon layer 16 may comprise any suitable carbon structure for adsorbing body odour (e.g. foot odour). For example, the activated carbon layer 16 may include activated carbon cloth or activated carbon felt (including activated charcoal felt). The activated carbon layer 16 is nano-porous and consequently has a comparatively large internal surface area for its size. This is configured to attract, trap and contain body odour molecules via the physical mechanism of Van Der Waals forces.

The first adhesive layer 118 is provided on the top surface of the second foraminous layer 114 and adheres the first foraminous layer 112 to the second foraminous layer 114, and adheres the foam layer 117 to the second foraminous layer 114. The first adhesive layer 118 may comprise a thermoplastic polymer for example. In other embodiments, the apparatus 110 may not include the first adhesive layer 18 and instead, the first foraminous layer 112, the activated carbon layer 116, the foam 117 and the second foraminous layer 114, may be coupled together via stitching (by a sewing machine for example).

The second adhesive layer 120 is provided on the bottom surface of the second foraminous layer 114 and is arranged to adhere the apparatus 110 to footwear. The second adhesive layer 120 may comprise a thermoplastic polymer for example. In other embodiments, the apparatus 110 may not include the second adhesive layer 120 and instead, the apparatus 110 may be coupled to footwear by stitching the apparatus 10 to the footwear (by a sewing machine for example).

The apparatus 110 also includes one or more materials for destroying odour causing bacteria. The first foraminous layer 112 and/or the second foraminous layer 114 and/or the activated carbon layer 116 and/or the foam layer 117 may comprise the one or more materials for destroying bacteria. The one or more materials may include a carboxylic acid (citric acid for example), noble metals (silver for example) or some non-noble metals such as copper. In one embodiment for example, the first and/or second foraminous layer 112, 114 comprises citric acid and the activated carbon layer 116 and the foam layer 117 include silver. In various embodiments, the one or more materials may also be for destroying viruses.

Where one or more of the layers 112, 114, 116 or 117 comprises a carboxylic acid, the layer 112, 114, 116 and 117 is immersed in a solution comprising the carboxylic acid. The layer 112, 114, 116 or 117 is then removed from the solution and then left to dry. When the layer 112, 114 116 or 117 is dry, the layer 112, 114 116 or 117 forms a nanosuspension comprising crystals of carboxylic acid. Where the activated carbon layer 116 comprises carboxylic acid, the concentration of the acid in the solution may be between 2% to 5% to prevent saturation of the activated carbon layer 116 by the acid.

Where one or more of the layers 112, 114 116 or 117 is to comprise a metal such as copper or silver, the layer 112, 114, 116 or 117 may be sprayed with (or immersed in) a solution comprising the metal and then left to dry. When the layer 112, 114 116 or 117 is dry, the layer 112, 114, 116 or 117 forms a nanosuspension comprising the metal.

Embodiments of the present invention provide several advantages. One such advantage is that the apparatus 110 may be incorporated into footwear and be used to adsorb foot odour. Consequently, even if a person uses little or no deodorant or anti-perspirant, the apparatus 110 suppresses foot odour from that person's feet.

The use of activated carbon cloth as the activated carbon layer 116 may be advantageous in that activated carbon cloth is relatively pure and has relatively consistently uniform nanoporous structures (when compared with activated charcoal felt) which result in the activated carbon cloth having relatively high Van Der Waals forces and being effective at adsorbing body and foot odour.

Another advantage provided by embodiments of the present invention is that the apparatus 110 may also include one or more materials for destroying odour causing bacteria. By destroying bacteria that produce body odour, the one or more materials may help to additionally suppress the production of body odour.

A further advantage provided by embodiments of the present invention is that the foam 117 increases the odour adsorbing effectiveness of the apparatus 110. When the apparatus 110 is placed in various positions within the footwear, it acts like bellows. When the foam layer 117 is pressed by the user's foot, air is displaced, and when pressure is released, air is drawn into the foam. The air passes over and through the activated carbon layer 117 and odour molecules are thereby adsorbed.

FIG. 12 illustrates a flow diagram of a method of manufacturing an apparatus 110 according to various embodiments of the present invention. At block 122, the method includes providing the activated carbon layer 116, the first foraminous material layer 112, the second foraminous material layer 114, and the foam layer 117.

At block 124, the method includes providing the apparatus 110 with one or more materials for destroying bacteria (as described in the preceding paragraphs).

At block 126, the method includes coupling the layers 112, 114, 116 and 117 together to form the apparatus 110. In various embodiments, block 126 may include the application of heat to melt the first adhesive layer 118 and thereby couple the layers 112, 114, 116, 117 together. A silicon based paper may be provided over the second adhesive layer 120 to prevent the second adhesive layer 120 from adhering to other objects. In other embodiments, block 126 may include stitching the layers 112, 114, 116 and 117 together.

At block 128, the method includes applying the apparatus 110 to the insole of footwear. In various embodiments, block 128 may include placing the apparatus 110 into footwear and then include the second adhesive layer 120 and thereby couple the apparatus 110 to the insole. The manufacture of an apparatus 110 and the coupling of the apparatus 110 to footwear will now be described with reference to FIGS. 13, 14, 15, 16 and 17.

As shown in FIG. 13, a piece of cotton gauze or any type of foraminous material 112 to which a fusible adhesive coating 118 may be applied, is cut to a predetermined pattern and placed with the fusible coating uppermost. The open cell foam 117 is then placed in position and then the activated carbon layer 116 is placed in position on top of the open cell foam 117 as shown in FIG. 14. Then, a second layer of cotton gauze or any type of foraminous material 114 is placed over the first layer 114 so as to sandwich the activated carbon layer 116 and the open cell foam 117 between the two layers 112, 114 as shown in FIG. 15.

The three layers 112, 114, 116 together with the open cell foam layer 117 are then placed together to allow the adhesive 118 on the first layer 112 to melt, fusing the four layers together to form the apparatus 110 as shown in FIG. 16. The apparatus 10 or 110 can then be incorporated or placed in the insole 130 of a shoe or footwear as shown in FIG. 17. The apparatus 110 can be positioned in the footwear by various means such as: stitching it in; or stitching onto the lining of the footwear; or adhering it to the body of the insole of the footwear or adhering it to the lining of the footwear, or anywhere within the area of the footwear.

The apparatus 10 or 110 may be incorporated in a similar manner into all types of footwear. The foam 117 within the apparatus 110 when placed in various positions within the footwear acts like bellows. When the foam is pressed by the foot, air is displaced, and when pressure is released, air is drawn into the foam. The air passes over and through the activated carbon trapping the odour molecules.

The blocks illustrated in the FIG. 12 may represent steps in a method and/or sections of code in a computer program. For example, the blocks in FIG. 12 may be executed by one or more processors to control the automated manufacture of an apparatus 110. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus for adsorption of body odour comprising:
an activated carbon layer for adsorbing body odour;
a first material layer; and
wherein the activated carbon layer is coupled to the first material layer.

2. An apparatus as claimed in claim 1, further comprising a second foraminous material layer, and wherein the first material layer is foraminous and the activated carbon layer is sandwiched between the first foraminous material layer and the second foraminous material layer.

3. An apparatus as claimed in claim 2, further comprising a third material layer including a plurality of open or closed cells.

4. An apparatus as claimed in claim 3, wherein the third material layer comprises one or more of: a polyester, a polyether or a poly urethane open or closed cell foam.

5. An apparatus as claimed in claim 3, wherein the third material layer is sandwiched between the activated carbon layer and the second foraminous material layer.

6. An apparatus as claimed in claim 3, wherein the third material layer is sandwiched between the activated carbon layer and the first foraminous material layer.

7. (canceled)

8. (canceled)

9. An apparatus as claimed in claim 1, wherein the activated carbon layer is a layer of activated carbon within a paper membrane.

10. An apparatus as claimed in claim 1, further comprising one or more materials for destroying bacteria.

11. An apparatus as claimed in claim 10, wherein the one or more materials are in the activated carbon layer.

12. (canceled)

13. An apparatus as claimed in claim 10, further comprising a second foraminous material layer and a third material layer including a plurality of open or closed cells, and wherein the first material layer is foraminous and the activated carbon layer is sandwiched between the first foraminous material layer and the second foraminous material layer, wherein the one or more materials are in the third material layer.

14. An apparatus as claimed in claim 10, further comprising a second foraminous material layer and wherein the first material layer is foraminous and the activated carbon layer is sandwiched between the first foraminous material layer and the second foraminous material layer, wherein the one or more materials are in the activated carbon layer and the first foraminous material layer and/or in the second foraminous material layer.

15. An apparatus as claimed in claim 10, wherein the one or more materials comprise a carboxylic acid, citric acid, one or more noble metals including copper, or silver.

16-18. (canceled)

19. An apparatus as claimed in claim 1, further comprising an adhesive layer for enabling the apparatus to be applied to a garment or footwear with a domestic iron or using an industrial fusing press.

20. (canceled)

21. A garment comprising one or more apparatus as claimed in claim 1.

22. Footwear comprising one or more apparatus as claimed in claim 1.

23. A method of manufacturing an apparatus for adsorption of body odour comprising:
providing an activated carbon layer for adsorbing body odour;
providing a first material layer; and
coupling the activated carbon layer to the first material layer.

24. A method as claimed in claim 23, further comprising providing a second foraminous material layer, and wherein the first material layer is foraminous and the activated carbon layer is sandwiched between the first foraminous material layer and the second foraminous material layer.

25. A method as claimed in claim 24, further comprising providing a third material layer including a plurality of open or closed cells.

26. A method as claimed in claim 25, wherein the third material layer comprises one or more of: a polyester, a polyether or a poly urethane open or closed cell foam.

27-41. (canceled)

42. A method comprising:
providing an apparatus as claimed in claim 1; and
coupling the apparatus to a garment or to footwear.

43-44. (canceled)
